(19) United States
(12) Patent Application Publication
(10) Pub. No.: US 2024/0232992 A9
(43) Pub. Date: Jul. 11, 2024

(54) SYSTEM AND METHOD FOR GUIDANCE OF CUSTOMERS IN A RETAIL STORE

(71) Applicant: Walmart Apollo, LLC, Bentonville, AR (US)

(72) Inventors: Komal Arvind Dhuri, San Jose, CA (US); Snehasish Mukherjee, Santa Clara, CA (US); Shankara Bhargava, Santa Clara, CA (US)

(21) Appl. No.: 18/279,444

(22) PCT Filed: Mar. 8, 2022
(86) PCT No.: PCT/US2022/019231

§ 371 Date: Aug. 30, 2023

Related U.S. Application Data
(60) Provisional application No. 63/157,878, filed on Mar. 8, 2021.

(51) Int. Cl. G06Q 30/0601

(52) U.S. Cl. CPC G06Q 30/0639

(57) ABSTRACT

A customer is provided with a customized and guided experience when shopping in-person in a retail store, distribution center, or other shopping area or location. Proactive actions that guide a customer through the store in a customized way are determined taking the customer's intent, customer's history with the store, customer's purchase history, and customer's location within the store (among other things} as inputs and rendering to the user guidance as to how to navigate or interact with or within the store.

### TECHNICAL FIELD

The technical field relates to the guidance of customers through retail stores to enhance the shopping experience of the customer while shopping.

### BACKGROUND

In-store shopping occurs where the customer physically enters a store to purchase products, return items, or perform some other function or obtain some service. On-line or virtual shopping is done without the customer ever entering the store and has become increasingly popular with customers. This type of shopping often relies upon personalized experiences such as easy navigable web-based product searches, single-screen shopping, product recommendations, auto-completes, cross-sells, and enhanced customer service.

Many of the advantages of on-line shopping have not been transferred to in-store shopping. For example, sometimes it is difficult for a customer to find a product. In other situations, customer service is not satisfactory to the customer. Ultimately, some customers complain that their in-store experience does not meet their individualized needs or expectations.

### BRIEF DESCRIPTION OF THE DRAWINGS

The above needs are at least partially met through the provision of approaches for the guidance of customers through retail stores, wherein:

FIG. 1 comprises a diagram of a system as configured in accordance with various embodiments of these teachings;

FIG. 2 comprises a flowchart as configured in accordance with various embodiments of these teachings;

FIG. 3 comprises a diagram of a system as configured in accordance with various embodiments of these teachings;

FIG. 4 comprises a diagram of a system as configured with various embodiments of these teachings;

FIG. 5 comprises a diagram of a system as configured with various embodiments of these teachings.

FIG. 6 comprises a diagram of a system as configured with various embodiments of these teachings.

### DETAILED DESCRIPTION

When permitted by law, the approaches described herein provide a customer, who has opted-in, with a customized and guided experience when shopping in-person in a retail store, distribution center, or other shopping area or location. These approaches determine proactive actions that guide a customer through the store in a customized way, taking the customer's intent, customer's history with the store, customer's purchase history, and customer's location within the store (among other things) as inputs and rendering to the user guidance as to how to navigate or interact with or within the store.

As used herein, “proactive” actions are actions that are intended to control, define, create, guide, and/or interact with a customer or the customer's experience within the store and anticipate and/or predict the customer's needs, goals, requirements, preferences, and/or expectations. In the context of the present approaches, proactive actions are intended and undertaken, among other things, to guide a customer, who has opted-in, through a store anticipating the needs, requirements, expectations, and generally enhance their shopping experience. These actions are customized for each individual customer making the set of actions that are performed unique (or at least potentially unique) for each customer. It will also be appreciated that the term “store” as used herein refers to any location, building, or other shopping area where a customer is present.

In some aspects, an in-store assistant device, apparatus, or system is provided that utilizes the customer's personal account history, in-store location, and other contextual information to provide an optimized customer experience. The customer, when utilizing the assistant, receives a personalized and customized guided experience through the store utilizing their past purchases, store set-up and departments, best possible navigation path, overall store environment and other factors to determine the guidance.

Advantageously, the assistant determines, presents, and/or provides proactive actions with minimum voice or text-based interaction between the customer and the assistant when the customer is in the store. In these regards and in examples, the assistant provides aisle-based offers, aisle-based product recommendations, cart total pop-ups (on screens monitored by the customer), checkout aisle navigation, pop-ups for curbside pickup and navigation of the customer to a spot or location within the store, personalized in-store extra help in specific store locations (e.g., near the pharmacy aisle) and easy pop-ups for the most commonly asked in-store questions for returns, store timing, vision center, and customer support (to mention a few topics).

In other aspects, a system proactively guides a customer through a store to give the customer a personalized shopping experience that proactively anticipates the needs of the customer. A customer utilizes an item container, e.g., a shopping cart, with an electronic display device such as a tablet. In-store related data related to the customer (e.g., the location of the customer), and customer intent data (showing what the customer wants to do such as purchase a particular product) are received at a control circuit. The control circuit routes the data to one of two neural networks. One network determines the intent of the customer and sends its output to the second network. The second network also receives the in-store related data and historical data concerning the customer. With these three sources of information, the second neural network determines a proactive action (e.g., send instructions to the customer to a particular aisle to purchase a product). The proactive actions are routed to the customer, for example, using a centralized control circuit (disposed at a central location and not remotely).

As mentioned, proactive actions are suggested and performed in the present approaches. For example, instructions are issued that guide a customer through the store to a particular aisle to purchase a product. Online product reviews are made available to the customer in-store for products picked by customer. Alternative products can be identified for consideration of the customer (e.g., a better product as alternative for poorly online reviewed product). In another example, help messages are sent to fetch store associate when a customer visits an aisle and the customer has questions or problems.

Contextual signals or information is obtained relating to or associated with customers. Typically, users utilize a combination of devices, apps, and other modalities their shopping journey. They might add products to the cart using the voice assistant, checkout using the app, check orders via on-line chat, and pick up their order physically from the store. All of these are part of the customer's shopping experience. This information is used as contextual signals or features in an event-based model to assist a text-based query model.

Various actions can be performed as a result of processing the contextual signals (as well as potentially other sources of information). For example, a product search aisle navigator is provided to allow the customer to navigate to a particular product. Messages or other information may be presented to customers that provide for the cross-selling or up-selling of different products that might be of interest to the customer, but that the customer did not enter the store with the specific intent to purchase. In aspects, the actions may be automatically performed and/or manually performed.

If it can be determined that the customer is locating products to fulfill a recipe, these approaches can provide cart completion where items that are needed to complete the recipe can be presented to the customer for purchase. The items in the recipe may be items the customer has specifically identified, but also may be other items that they have not identified but still need to complete the recipe.

Other examples of proactive actions include performing a product search for products the custom desires and may need, determining and informing the customer of out-of-stock products, and facilitating online cart additions for items that might not be in the store.

Information can also be provided to the customer about the return aisle (when a determination is made that the customer is returning an item or when a determination is made that the customer is likely in the store to return an item), order receipt, and product replacement.

Aisle based offers and aisle-based product recommendations can be provided to the customer (e.g., the customer is in a specific aisle, offers that anticipate the customer's needs can be made such as discount or coupons for certain products). Information can be presented to the customer such as cart total pop-ups checkout aisle navigator, and pop-ups for curbside pickup and navigation to spot in the store. Additionally, personalized in-store help near certain locations in the store (e.g., the pharmacy aisle) and easy pop-ups for the most commonly asked in store questions can also be provided.

In many of these embodiments, a system for proactively guiding customers through a retail store and improving the experience of the customer in the retail store includes an item container, a database, a control circuit, a first neural network, and a second neural network.

The item container (e.g., a shopping cart) includes an electronic display device, and the item container is disposed at a retail store. The database is disposed at a central operation center and includes historical customer information. The control circuit is disposed at the central operations center and is coupled to the database.

The first neural network is coupled to the control circuit and the database. The second neural network is coupled to the control circuit and the first neural network.

The control circuit is configured to: receive customer context data associated with and obtained from the customer, route a first portion of the customer context data to the first neural network, and route a second portion of the customer context data to the second neural network. The first neural network responsively produces customer intent information and transmits the customer intent information to the second neural network. The second neural network receives the customer intent information, the second portion of customer context data, and the historical customer information and responsively produces a suggested proactive action for implementation or execution by the customer.

The control circuit is configured to receive the suggested proactive action and send instructions to the item container to present the suggested proactive action to the customer at the electronic display device. The customer navigates the item container through the store or takes another action according to the suggested proactive action.

In aspects, the electronic display device comprises a tablet, a cellular phone, a voice-only device, a smartphone, or a personal computer. Other examples of electronic display devices are possible.

In other aspects, the second portion of the customer context data includes the location of the customer within the store. Other examples are possible.

In examples, the first portion of the customer context data indicates an item the customer desires to purchase or return. Other examples of information are possible.

In still other examples, the instructions are sent to an employee of the store. For instance, the instructions ask the employee to aid the customer. Other types of instructions can also be sent.

In other aspects, the item container or electronic display device includes one or more sensors, the one or more sensors configured to acquire the customer context data. For instance, the one or more sensors include a camera, a microphone, or a scanner.

In still other examples, the customer configures the electronic display device so as to be usable by the customer. For example, the customer may scan an app into the electronic display device thereby enabling the electronic display device to be utilized by the customer.

In yet other examples, the item container is a shopping cart. Other examples of item containers such as shopping baskets are possible.

In others of these embodiments, an approach for proactively guiding customers through a retail store and improving the experience of the customer in the retail store includes providing an item container (e.g., a shopping cart) with an electronic display device. The item container being disposed at a retail store. Historical customer information is stored at a database, the database being disposed at a central operation center.

A control circuit is disposed at the central operations center. A first neural network and a second neural network are also provided.

At the control circuit, customer context data associated with and obtained from the customer is received, a first portion of the customer context data is routed to the first neural network, and a second portion of the customer context data is routed to the second neural network.

The first neural network responsively produces customer intent information and transmits the customer intent information to the second neural network.

At the second neural network, the customer intent information, the second portion of customer context data, and the historical customer information are received and the second neural network responsively produces a suggested proactive action. The suggested proactive action suggests an action for implementation by the customer.

At the control circuit, the suggested proactive action is received and instructions sent to the item container to present the suggested proactive action to the customer at the electronic display device.

The customer navigates the item container through the store or takes another action according to the suggested proactive action.

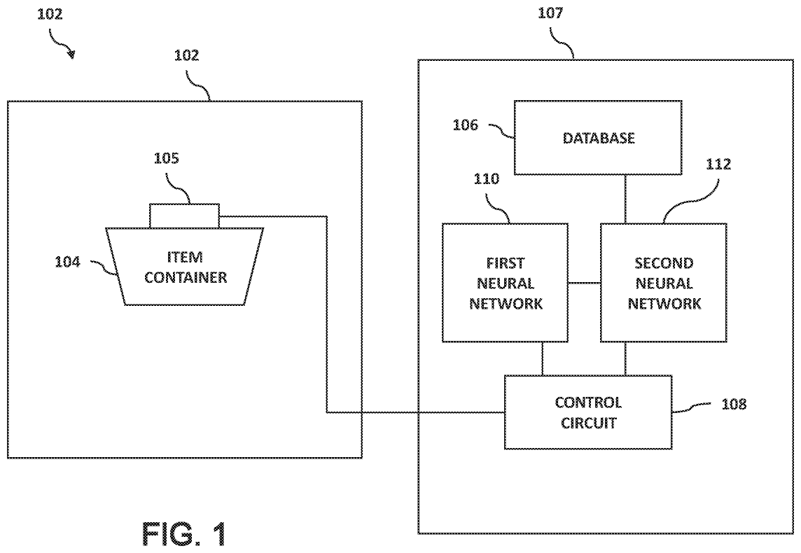

Referring now to FIG. 1, a system 100 for proactively guiding customers through a retail store 102 and improving the experience of the customer in the retail store 102 includes an item container 104, a database 106, a control circuit 108, a first neural network 110, and a second neural network 112.

The retail store 102 is any type of retail establishment providing products and/or services to customers. The retail store 102 may be any type of retail store selling products (or services) to customers, a distribution center, or a market to mention a few examples. However, other settings or environments besides retail stores such as warehouses are possible and can be used as locations for implementing the approaches described herein.

The item container 104 includes an electronic display device 105. The item container 104 is disposed at the retail store 102. In examples, the item container 104 is a shopping cart. Other types of item containers including shopping baskets are also possible.

The database 106 is disposed at a central operation center 107. The database 106 includes historical customer information. The database 106 is any type of electronic memory device. The central operation center 107 is any central location such as a company headquarters or centralized service center. Historical customer information includes data showing the previous purchases, purchase patterns, or any other previous purchase information concerning a customer. For example, the types, amounts and frequency of purchases of particular products may be included with the historical customer information.

The first neural network 110 is coupled to the control circuit 108 and the database 106. The second neural network 112 is coupled to the control circuit 108 and the first neural network 110. The first neural network 110 and second neural network 112 may also be deployed at the central operations center 107 and are any type of neural network, machine learning model, or similar type of structure such as a convolutional neural network (CNN). Other examples are possible.

The control circuit 108 is disposed at the central operations center 107 and is coupled to the database 106. The central operations center 107 may be, in examples, a company headquarters or any other central location. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here.

In one example of the operation of the system of FIG. 1, a customer enters the store 102 with their smartphone and an app on the smartphone that is associated with the store 102. The customer obtains an item container 104 (e.g., a shopping cart). The shopping cart has a computer tablet (the electronic display device 105) that is attached to the shopping cart. The user scans the app (or information associated with or identifying the app) into the tablet thereby telling the tablet that the customer is present, identifying the customer, and that the customer is ready to shop or perform other actions in the store 102. The tablet may have a microphone, a camera, and a geolocation sensor (showing the position of the customer or allowing their position in the store to be determined). Information from the user is collected, for instance the position of the user in the store and a voice message from the user (e.g., “I want to buy 5 bananas”). This information is referred to as the customer context data.

The control circuit 108 is configured to receive the customer context data associated with and obtained from the customer; route a first portion of the customer context data to the first neural network 110; and route a second portion of the customer context data to the second neural network 112. The first portion may include the voice message. The second portion may be related to the customer's position (e.g., customer coordinates in the store 102).

After receiving the first portion, the first neural network 110 responsively produces customer intent information and transmits the customer intent information to the second neural network 112. The first neural network 110 may parse through the message to determine the intent of the customer and produce the intent information, which may be in any appropriate data format. The intent information indicates that the customer is in the store to purchase the bananas. The second neural network 112 receives the customer intent information, the second portion of customer context data, and the historical customer information and responsively produces a suggested proactive action for implementation or execution by the customer. It will be appreciated that routing the various types of information described herein may be accomplished over various types of electronic communication networks or combinations of these networks.

The control circuit 108 is configured to receive the suggested proactive action and send instructions to the item container 104 to present the suggested proactive action to the customer at the electronic display device 105. The customer navigates the item container through the store or takes another action according to the suggested proactive action. In some examples, the suggested proactive action may control the operation of electronic devices (e.g., cause an electronic device to render informational content on a display).

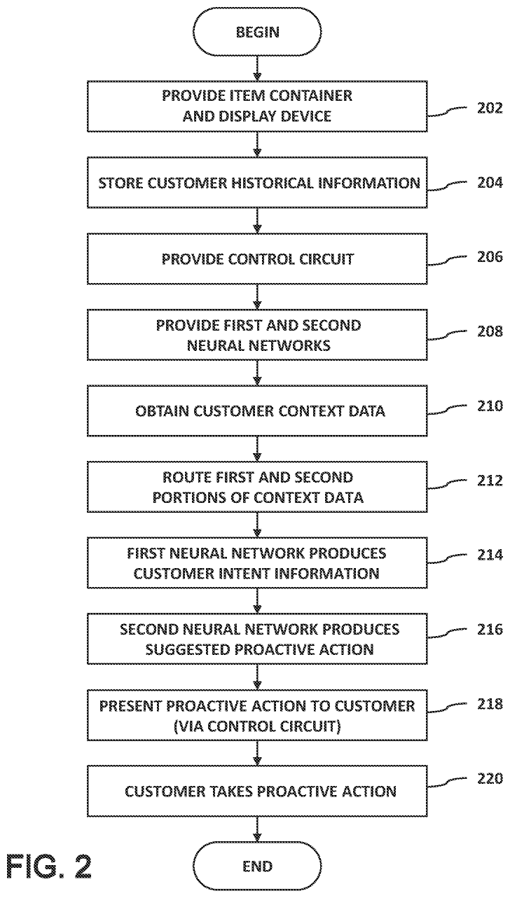

Referring now to FIG. 2, an approach for proactively guiding customers through a retail store and improve the experience of the customer in the retail store is described.

At step 202, an item container with an electronic display device is provided, and the item container is disposed at a retail store. In examples, the item container is a shopping cart of the type typically found in retail stores.

At step 204, historical customer information is stored at a database, and the database is disposed at a central operation center. Historical customer information includes data showing the previous purchases, purchase patterns, or any other previous purchase information concerning a customer. For example, the types, amounts, timing, offers utilized by a customer (e.g., coupons used), and frequency of purchases of particular products may be included with the historical customer information. The information may be included in any type of data structure or combination of data structures.

At step 206, a control circuit is provided and the control circuit is disposed at the central operations center. The control circuit is any microcontroller, computer, or processor-based device with processor, memory, and programmable input/output peripherals, which is generally designed to execute computer instructions that implement any of the functions described herein.

At step 208, a first neural network and a second neural network are provided. The neural networks are any type of neural network, machine learning model, or similar type of structure such as convolutional neural networks (CNNs). The networks may be trained previously with sets of training data.

The neural networks described herein can have various structures. For example, the neural networks can have various layers. Each of the layers performs a specific function. In aspects, these layers comprise nodes. In one example, an input layer receives input signals or data and transfers this information to the next layer. One or more other layers perform calculations or make determinations. An output layer transmits the result of the calculations or determinations. If the network is a CNN, one or multiple convolutional layers are included in the network structure. In aspects, the convolutional layers apply a convolutional function on the input before transferring it to the next layer.

At step 210 and by the control circuit, customer context data associated is obtained from the customer and this data is received.

At step 212, a first portion of the customer context data is routed to the first neural network, and a second portion of the customer context data is routed to the second neural network.

At step 214, the first neural network responsively produces customer intent information and transmits the customer intent information to the second neural network. As mentioned, the neural networks may be previously trained to produce the information.

At step 216 and at the second neural network, the customer intent information, the second portion of customer context data, and the historical customer information are received and the second neural network responsively produces a suggested proactive action. The suggested proactive action suggests an action for implementation by the customer. As mentioned, the neural networks may be previously trained to produce the information.

At step 218 and at the control circuit, the suggested proactive action is received and instructions sent to the item container to present the suggested proactive action to the customer at the electronic display device.

At step 220, the customer navigates the item container through the store or takes another action according to the suggested proactive action.

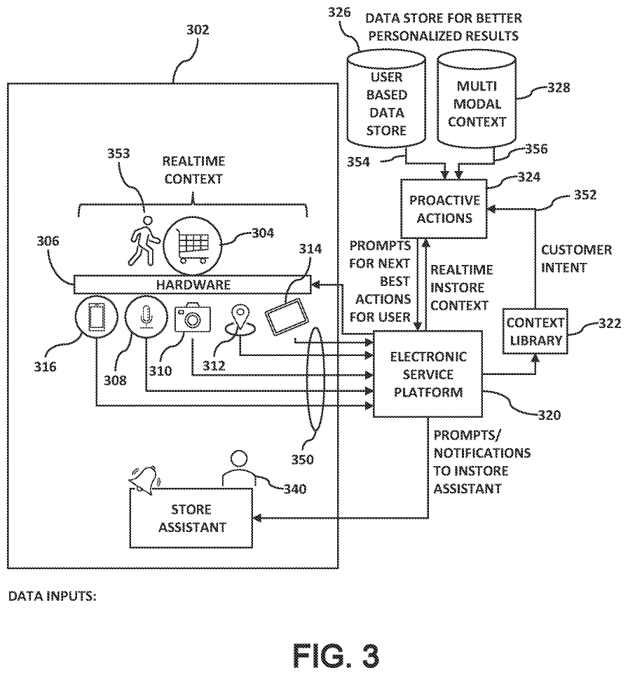

Referring now to FIG. 3, another example of a system that provides a guided customer experience through a retail store is described. The system includes a retail store 302, which may be any store that offers products or services for sale to the public. The retail store 302 includes a shopping cart or other item container 304 with a computer tablet 306. It will be appreciated that the tablet 306 could instead be a smartphone or smartphone-type device, personal computer, laptop, or some other similar electronic device. The tablet 306 includes a microphone 308, a camera 310, a location sensor 312, a keyboard 314, and a screen 316. Together, the output from these sensors forms real time context information 350 of a customer 303. The real time context information 350 generally defines the context of the customer. By “context,” it is meant the circumstances, position, environment, conditions, and/or states the customer 303 finds themselves in or with at a given location or position within the retail store 302.

An electronic service platform 320 may include a control circuit that routes incoming and out-going information. The electronic service platform 320 may comprise any combination of computer hardware (e.g., electronic processing devices) and/or computer software. The control circuit may operate the same or similar manner as, for example, the control circuit 108 of FIG. 1 described elsewhere herein.

A context library 322, for example, a neural network, determines intent information 352 defining the intent of the customer 303. A proactive actions determination device or structure 324 determines a suggested proactive action that is related to the customer 303. The proactive actions determination device or structure 324 may be a neural network. The inputs to the proactive actions determination device or structure 324 are intent information 352 received from the context library 322, real time context information 350 received from the tablet 306, user-based historical information 354 received from a first data store 326, and store context information 356 received from a second data store 328.

In one example of the operation of a system 300 of FIG. 3, the customer 303 enters the store 302 with their smartphone and an app on the smartphone that is associated with or provided by the store 302. The customer obtains the shopping cart 304. The user scans the app (or information relating to the app, this information identifying the customer) into the tablet 306 thereby informing the tablet 306 that the customer 303 is present and ready to shop or perform other actions in the store 302. Information from the customer 303 is collected, for instance the position of the customer 303 in the store 302, and a voice message from the user 303 (e.g., “I want to buy a box of oatmeal cereal from Brand XYZ, and have an item to return.”).

This information is received at the electronic service platform 320 (e.g., at a central location), and the platform 320 makes routing decisions as to different destinations where to forward the information. Two of the locations that the information can be routed are the context library 322 and the proactive actions determination device or structure 324. It will be appreciated that the routing of information may involve physically separating the information into different information streams. As mentioned and in aspects, both of these locations/entities 322, 324 are neural networks.

The context library 322 determines the intent of the user. This may be gleaned from the message by applying natural langue processing techniques on the message. In this example, the intent may be “to purchase items” with the items being a box of oatmeal cereal. Another intent is to return an hem. As mentioned, standard machine learning techniques that include natural language processing approaches can be used to obtain the information.

Also as mentioned, the proactive actions determination device or structure 324 is another neural network that receives the output of the context library 322 and also the real time context (e.g., location) of the customer. The proactive actions determination device or structure 324 determines a proactive action. In this example, assuming the customer is in the wrong aisle, the proactive actions determination device or structure 324 determines that a proactive action would be to inform the customer to move over two aisles (to the correct aisle). Information may be received of previous purchases by the customer for other products (e.g., milk) that may also be purchased by the customer. Store data may also be received showing that certain areas of the store 302 may be busier than others, thus guiding the customer on an optimal path through the store 302.

Proactive actions determination device or structure 32.4 takes all this information, processes it through a neural network, and determines actions. These actions may include: determining a customized path of how the customer should proceed through the store 302, e.g., from the cereal area of the store 302, to the milk section of the store 302, to the return area of the store 302, or some other sequence; identification of the correct aisle to find the oatmeal cereal assuming the customer is in the wrong aisle (and informing the customer of this information); if a particular product is not available, suggest substitute products; and provide information as to how the customer can check out in the store 302 and purchase their products.

The determined proactive action or actions are sent to the platform 320, which decides how to present it to the customer 303. For example, the platform 320 may decide that the best way is to send a message to a display screen on the tablet 306. The messages are communicated according to any type of communication network, structure, or combination.

In other examples, proactive actions can be also communicated to store employees 340 or an electronic device with the store employee 340. For example, an employee 340 may be instructed to meet a customer at a particular location if the customer appears to need help (e.g., the context information indicates they are wandering in the wrong aisle).

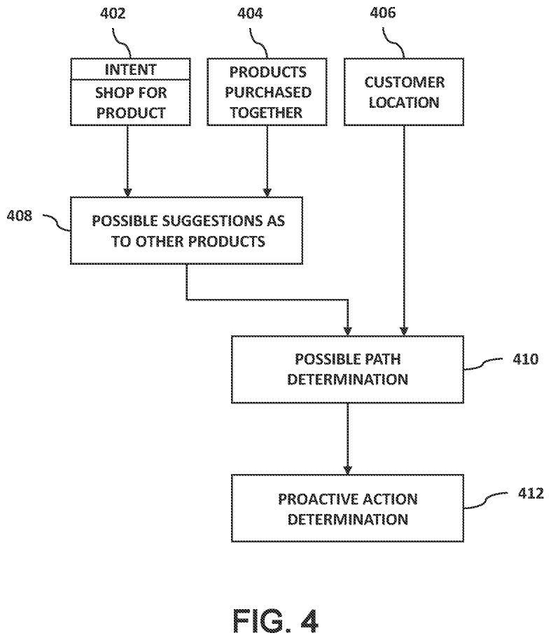

Referring now to FIG. 4, one example of the functions that can be provided by a proactive actions determination device or structure are described. Although these actions are described in relation to a flow diagram, it will be appreciated that these actions can be implemented as a properly trained neural network where certain inputs that are applied to the network to produce output that is the suggested proactive action.

The neural network receives inputs 402 showing the intent of the customer (e.g., that is obtained from the context library 322 of FIG. 3 or the first neural network 110 of FIG. 1). The neural network also receives products typically purchased together by the customer (or by other customers) at input 404. These may be received from a historical database (e.g., the first and second data stores 326 and 328 of FIG. 3). The neural network also receives customer location information 406 (e.g., location coordinates within the store).

At operation 408, the neural network determines using the inputs 402 and 404 possible suggestions as to other products the customer may wish to purchase in addition to the product they intend to purchase. For example, the inputs 404 may inform that the customer always purchases cereal and milk together or that store customers are likely to purchase these products together. In other examples, other suggestions may be made and other customer context data obtained.

At operation 410, the neural network determines a possible path for the customer based upon the products that the customer is to purchase (the products the customer intends to purchase and the products to recommend to purchase at operation 408), and the location of the customer. This may involve using a shortest path or the shortest path that is not congested with other customers.

At operation 412, the neural network outputs the suggested proactive action. In this case, the action may be to proceed along the path determined at step 410 to obtain the products.

It will be appreciated that the operations described herein may, in aspects, be implemented in the various layers, connections, weightings, and other structural details of a neural network that has been trained to produce these results. It also will be understood that this is one example and that other examples are possible.

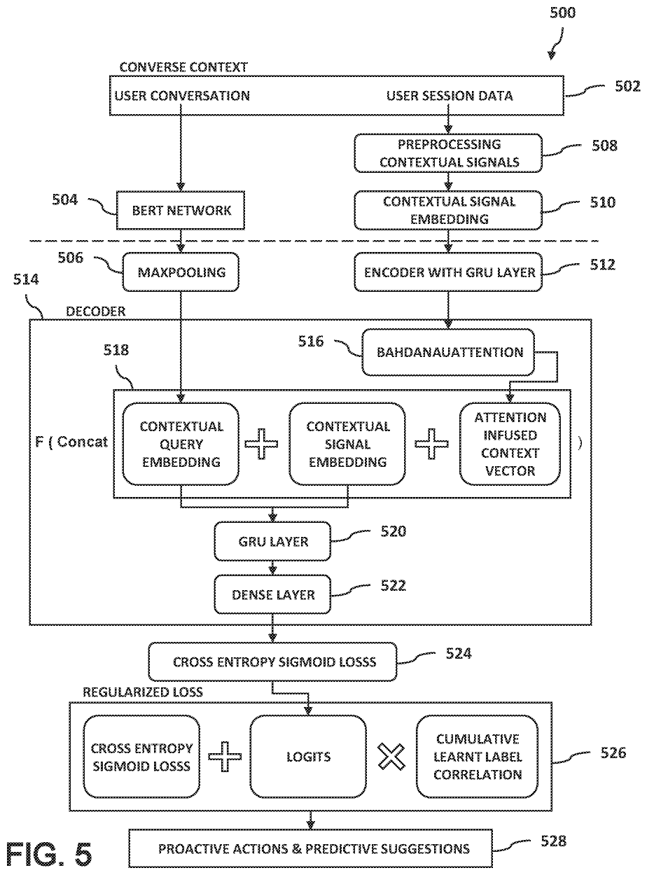

Referring now to FIG. 5, one example of a deep learning algorithm 500 is described. These operations and steps may be performed by one or more neural networks.

A user conversation and other user session data (e.g., user or customer location, items just purchased by the user or customer, and/or user or customer history received from a database to mention a few examples) are received at operation 502.

A bidirectional encoder representation from transformer (BERT) network 504 is a machine learning approach for natural language processing. Applying, for example, user voice or text messages to the BERT network 504 allows understanding of the intent of the conversation (e.g., the user intends to purchase a specific item). Max pooling (a sample-based discretization process) is performed at step 506 using the output of the BERT network as its input.

Preprocessing the contextual signals (step 508), contextual signal embedding (step 510) and encoding using an encoder with a gated recurrent unit (GRU) layer (at step 512), converts the contextual signals into forms understandable by a neural network and embeds the signals into understandable messages. GRU layers are gating mechanisms typically used in recurrent neural networks.

A decoder 514 includes a bahdanau attention mechanism 516, which performs generation of context vectors. The decoder 514 performs a concatenation operation at step 518. A GRU layer 520 and a dense layer 522 apply matrix operations. Dense layers, in some aspects, are non-linear layers and can be represented as formulas.

Cross entropy and sigmoid loss function 524 is another layer and is applied as a loss function. This operation generally calculates the difference between two probability distributions.

Operation 526 converts numeric information into text information to produce proactive suggestions 528. The proactive suggestions 528 can then be further processed and actions taken based upon these suggestions. For example, the proactive suggestions 528 may include instructions for a user or customer to take in a store; these may be communicated to a customer; and the customer may take actions based on the suggestions to move through the store according to the suggestions.

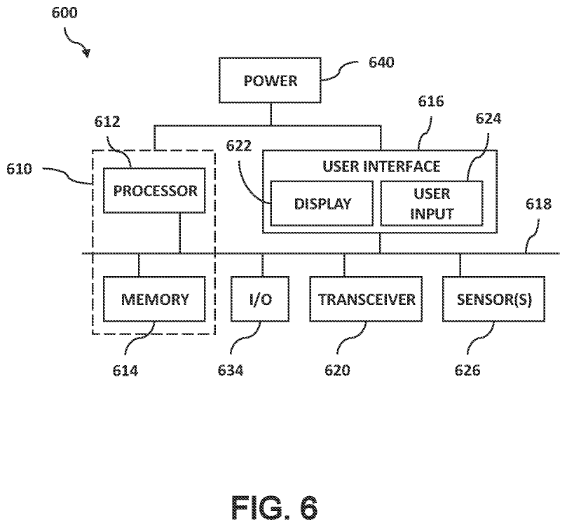

Further, the circuits, circuitry, systems, devices, processes, methods, techniques, functionality, services, servers, sources and the like described herein may be utilized, implemented and/or run on many different types of devices and/or systems. FIG. 6 illustrates an exemplary system 600 that may be used for implementing any of the components, circuits, circuitry, systems, functionality, apparatuses, processes, or devices of the system 100 of FIG. 1 or system 300 of FIG. 3, and/or other above or below mentioned systems or devices, or parts of such circuits, circuitry, functionality, systems, apparatuses, processes, or devices. For example, the system may be used to implement some or all of the control circuits, neural networks, platforms, one or more of the databases, and/or other such components, circuitry, functionality and/or devices. However, the use of the system 600 or any portion thereof is certainly not required.

By way of example, the system 600 may comprise a processor module 612, memory 614, and one or more communication links, paths, buses or the like 618. Some embodiments may include one or more user interfaces 616, and/or one or more internal and/or external power sources or supplies 640. The processor module 612 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor module 612 can be part of control circuitry and/or a control system 610, which may be implemented through one or more processors with access to one or more memory 614 that can store commands, instructions, code and the like that is implemented by the processor module to implement intended functionality. In some applications, the processor module and/or memory may be distributed over a communications network (e.g., LAN, WAN, Internet) providing distributed and/or redundant processing and functionality. Again, the system 600 may be used to implement one or more of the above or below, or parts of, components, circuits, systems, processes and the like.

The user interface 616 can allow a user to interact with the system 600 and receive information through the system. In some instances, the user interface 616 includes a display 622 and/or one or more user inputs 624, such as buttons, touch screen, track ball, keyboard, mouse, etc., which can be part of or wired or wirelessly coupled with the system 600. Typically, the system 600 further includes one or more communication interfaces, ports, transceivers 620 and the like allowing the system 600 to communicate over a communication bus, a distributed computer and/or communication network (e.g., a local area network (LAN), the Internet, wide area network (WAN), etc.), communication link 618, other networks or communication channels with other devices and/or other such communications or combination of two or more of such communication methods. Further the transceiver 620 can be configured for wired, wireless, optical, fiber optical cable, satellite, or other such communication configurations or combinations of two or more of such communications. Some embodiments include one or more input/output (I/O) ports 634 that allow one or more devices to couple with the system 600. The I/O ports can be substantially any relevant port or combinations of ports, such as but not limited to USB, Ethernet, or other such ports. The I/O interface 634 can be configured to allow wired and/or wireless communication coupling to external components. For example, the II/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 626 (e.g., sensors shown in FIG. 3) to provide information to the system and/or sensor information that is communicated to another component, such as the central control system, a delivery vehicle, etc. The sensors can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors, or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The system 600 comprises an example of a control and/or processor-based system with the processor module 612. Again, the processor module 612 can be implemented through one or more processors, controllers, central processing units, logic, software and the like. Further, in some implementations the processor module 612 may provide multiprocessor functionality.

The memory 614, which can be accessed by the processor module 612, typically includes one or more processor-readable and/or computer-readable media accessed by at least the processor module 612, and can include volatile and/or nonvolatile media, such as RAM, ROM, EEPROM, flash memory and/or other memory technology. Further, the memory 614 is shown as internal to the control system 610; however, the memory 614 can be internal, external or a combination of internal and external memory. Similarly, some or all of the memory 614 can be internal, external or a combination of internal and external memory of the processor module 612. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over a computer network. The memory 614 can store code, software, executables, scripts, data, content, lists, programming, programs, log or history data, user information, customer information, product information, and the like. While FIG. 6 illustrates the various components being coupled together via a bus, it is understood that the various components may actually be coupled to the control circuit and/or one or more other components directly.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A system for proactively guiding customers through a retail store and improving the experience of the customer in the retail store, the system comprising:
an item container with an electronic display device, the item container being disposed at a retail store;
a database disposed at a central operation center, the database including historical customer information;
a control circuit disposed at the central operations center, the control circuit being coupled to the database;
a first neural network coupled to the control circuit and the database;
a second neural network coupled to the control circuit and the first neural network;
wherein the control circuit is configured to:
receive customer context data associated with and obtained from the customer;
route a first portion of the customer context data to the first neural network;
route a second portion of the customer context data to the second neural network;
wherein the first neural network responsively produces customer intent information and transmits the customer intent information to the second neural network;
wherein the second neural network receives the customer intent information, the second portion of customer context data, and the historical customer information and responsively produces a suggested proactive action for implementation or execution by the customer;
wherein the control circuit is configured to receive the suggested proactive action and send instructions to the item container to present the suggested proactive action to the customer at the electronic display device;
wherein the customer navigates the item container through the store or takes another action according to the suggested proactive action.

2. The system of claim 1, wherein the electronic display device comprises a tablet, a cellular phone, a voice-only device, a smartphone, or a personal computer.

3. The system of claim 1, wherein the second portion of the customer context data includes the location of the customer within the store.

4. The system of claim 1, wherein the first portion of the customer context data indicates an item the customer desires to purchase or return.

5. The system of claim 1, wherein the instructions are sent to an employee of the store.

6. The system of claim 5, wherein the instructions ask the employee to aid the customer.

7. The system of claim 1, wherein the item container or electronic display device includes one or more sensors, the one or more sensors configured to acquire the customer context data.

8. The system of claim 7, wherein the one or more sensors include a camera, a microphone, or a scanner.

9. The system of claim 1, wherein the customer configures the electronic display device so as to be usable by the customer.

10. The system of claim 1, wherein the item container is a shopping cart.

11. A method for proactively guiding customers through a retail store and improve the experience of the customer in the retail store, the system comprising:
providing item container with an electronic display device, the item container being disposed at a retail store;
storing historical customer information at a database, the database being disposed at a central operation center;
disposing a control circuit at the central operations center;
providing a first neural network;
providing a second neural network;
at the control circuit, receiving customer context data associated with and obtained from the customer, routing a first portion of the customer context data to the first neural network, and routing a second portion of the customer context data to the second neural network, wherein the first neural network responsively produces customer intent information and transmits the customer intent information to the second neural network;
at the second neural network, receiving the customer intent information, the second portion of customer context data, and the historical customer information and responsively producing a suggested proactive action, the suggested proactive action suggesting an action for implementation by the customer;
at the control circuit, receiving the suggested proactive action and sending instructions to the item container to present the suggested proactive action to the customer at the electronic display device;
wherein the customer navigates the item container through the store or takes another action according to the suggested proactive action.

12. The method of claim 11, wherein the electronic display device comprises a tablet, a cellular phone, a voice-only device, a smartphone, or a personal computer.

13. The method of claim 11, wherein the second portion of the customer context data includes the location of the customer within the store.

14. The method of claim 11, wherein the first portion of the customer context data indicates an item the customer desires to purchase or return.

15. The method of claim 11, wherein the instructions are sent to an employee of the store.

16. The method of claim 15, wherein the instructions ask the employee to aid the customer.

17. The method of claim 11, wherein the item container or electronic display device includes one or more sensors, the one or more sensors configured to acquire the customer context data.

18. The method of claim 17, wherein the one or more sensors include a camera, a microphone, or a scanner.

19. The method of claim 11, wherein the customer configures the electronic display device for use by the customer.

20. The method of claim 11, wherein the item container is a shopping cart.
